(19) United States
(12) Patent Application Publication
(10) Pub. No.: US 2016/0370897 A1
(43) Pub. Date: Dec. 22, 2016

(54) IN CELL TOUCH PANEL AND DISPLAY DEVICE

(71) Applicants: BOE TECHNOLOGY GROUP CO., LTD., Beijing (CN); BEIJING BOE OPTOELECTRONICS TECHNOLOGY CO., LTD., Beijing (CN)

(72) Inventors: Weijie ZHAO, Beijing (CN); Xue DONG, Beijing (CN); Shengji YANG, Beijing (CN); Yingming LIU, Beijing (CN)

(73) Assignees: BOE TECHNOLOGY GROUP CO., LTD., Beijing (CN); BEIJING BOE OPTOELECTRONICS TECHNOLOGY CO., LTD., Beijing (CN)

(21) Appl. No.: 15/182,725

(22) Filed: Jun. 15, 2016

(30) Foreign Application Priority Data
Jun. 17, 2015 (CN) 201510337184.5

(51) Int. Cl. G06F 3/044; G06F 3/041

(52) U.S. Cl. CPC G06F 3/044; G06F 3/0416

(57) ABSTRACT

The present disclosure provides an in cell touch panel and a display device. The in cell touch panel includes an upper substrate and a lower substrate arranged opposite to each other; a self capacitance electrode between the upper substrate and the lower substrate; a ground electrode corresponding to the self capacitance electrode; and a driving circuit configured to apply a signal to the self capacitance electrode and the ground electrode, wherein the driving circuit is configured to apply a same touch scanning signal to the self capacitance electrode and the ground electrode during a touch phase.

### CROSS-REFERENCE TO RELATED APPLICATION

The present application claims a priority of the Chinese patent application No. 201510337184.5 filed on Jun. 17, 2015, which is incorporated herein by reference in its entirety.

### TECHNICAL FIELD

The present disclosure refers to the field of touch technology, in particular to an in cell touch panel and a display device.

### BACKGROUND

With the rapid development of the display technology, touch screen panel has been gradually spread in daily lives. Currently, touch panels may be divided into add on mode touch panels, on cell touch panels and in cell touch panels according to their structures. For an add on mode touch panel, a touch screen and a liquid crystal display (LCD) are manufactured separately, and then adhered together to form the LCD with touch functionality. The add on mode touch panel has the disadvantages of a high manufacturing cost, a low light transmission rate and a thick module. For an in cell touch panel, touch electrodes of the touch panel are embedded in the LCD so that the module thickness is decreased, the manufacturing cost is reduced. Such touch panels are desirable for various touch panel manufactures.

Currently, the existing in cell touch panel detects a touch position by a finger by utilizing a mutual capacitance or a self capacitance principle. A plurality of self capacitance electrodes which are arranged at the same layer and isolated from each other are provided in the touch panel when the self capacitance principle is used. When a person does not touch the touch panel, a base capacitance of each self capacitance electrode (a capacitance of the self capacitance electrode to ground) is a constant. When the touch panel is touched, a body capacitance is added to the base capacitance. A touch detection IC detects the change of the capacitance of each self capacitance electrode during a touch period so as to determine the touch position. Since the body capacitance works for all self capacitance electrode instead of only works for a projection capacitance of the mutual capacitance, the change of the capacitance caused by body touching in self capacitance detection is larger than that of the mutual capacitance detection. Therefore, as compared with a mutual capacitance touch panel, a touching signal-to-noise ratio (SNR) is improved in a self capacitance touch panel, so that touch accuracy is improved.

However, when the self capacitance electrode has a relative large base capacitance, the change of the capacitance caused by body touching is small relative to the big base capacitance, the touching SNR is adversely affected. Therefore, how to reduce the base capacitance of the self capacitance electrode so as to increase the change of the capacitance caused by body touching relative to the base capacitance is an urgent problem to be solved.

### SUMMARY

An object of the present disclosure is to provide an in cell touch panel and a display device, so as to decrease the base capacitance of the self capacitance electrode and improve touching accuracy.

In one aspect, the present disclosure provides in some embodiments an in cell touch panel, including an upper substrate and a lower substrate arranged opposite to each other; a self capacitance electrode between the upper substrate and the lower substrate; a ground electrode corresponding to the self capacitance electrode; and a driving circuit configured to apply a signal to the self capacitance electrode and the ground electrode, wherein the driving circuit is configured to apply a same touch scanning signal to the self capacitance electrode and the ground electrode during a touch phase.

Alternatively, the self capacitance electrode is arranged on a side of the upper substrate facing the lower substrate, the ground electrode comprises a common electrode, a data line and a gate line which are arranged on a side of the lower substrate facing the upper substrate, the driving circuit is further configured to apply a common electrode signal to the common electrode, a data signal to the data line and a gate scanning signal to the gate line during a display phase.

Alternatively, the in cell touch panel further includes a black matrix arranged on one of the side of the upper substrate facing the lower substrate and the side of the lower substrate facing the upper substrate, wherein a projection of the black matrix on the lower substrate overlaps a projection of the self capacitance electrode on the lower substrate.

Alternatively, the self capacitance electrodes are arranged in a matrix manner, the common electrode is divided into a plurality of block-like common sub-electrodes corresponding to respective self capacitance electrodes.

Alternatively, the self capacitance electrodes are arranged in a matrix manner, the common electrode is divided into a plurality of stripe-like common sub-electrodes corresponding to respective columns of self capacitance electrodes.

Alternatively, the self capacitance electrodes are arranged in a matrix manner, the common electrode is divided into a plurality of stripe-like common sub-electrodes corresponding to respective rows of self capacitance electrodes.

Alternatively, the in cell touch panel further includes a first connection line arranged on a region corresponding to a block-like self capacitance electrode and connected to the block-like self capacitance electrode through a via hole, wherein the first connection line and one of the gate line and the data line are isolated from each other, and arranged on the same layer in parallel.

Alternatively, the in cell touch panel further includes a second connection line arranged on a region corresponding to a strip-like self capacitance electrode and connected to the stripe-like self capacitance electrode through a via hole, wherein the second connection line and the data line are isolated from each other, and arranged on the same layer in parallel.

Alternatively, the in cell touch panel further includes a second connection line arranged on a region corresponding to a strip-like self capacitance electrode and connected to the stripe-like self capacitance electrode through a via hole, wherein the second connection line and the gate line are isolated from each other, and arranged on the same layer in parallel.

Alternatively, the self capacitance electrode is arranged on a side of the lower substrate facing the upper substrate and the self capacitance electrode is also used as the common electrode, the ground electrode comprises a data line and a gate line arranged on a side of the lower substrate facing the upper substrate; the driving circuit is further configured to apply a common electrode signal to the self capacitance electrode, apply a data signal to the data line and apply a gate scanning signal to the gate line during the display phase.

Alternatively, each self capacitance electrode is connected to the driving circuit through a corresponding conductive line, the conductive line and the data line is isolated from each other and arranged on the same layer in parallel, and a layer on which the data line is arranged is between a layer on which the self capacitance electrode is arranged and a layer on which the gate line is arranged, the conductive line is connected to the corresponding self capacitance electrode through a via hole.

Alternatively, the in cell touch panel further includes a plurality of sub-pixels arranged on the side of the lower substrate facing the upper substrate and in a matrix manner, two gate lines are arranged between adjacent rows of sub-pixels, a pixel group including every two adjacent columns of sub-pixels shares one data line between the two adjacent columns of the sub-pixels, the conductive line is arranged in a gap between adjacent pixel groups.

Alternatively, the in cell touch panel further includes a third connection line which is arranged a region corresponding to a self capacitance electrode and connected to the self capacitance electrode through a via hole, wherein the third connection line and the data line are isolated and arranged on the same layer in parallel.

Alternatively, the in cell touch panel further includes a plurality of fourth connection lines which are arranged a region corresponding to a conductive line and connected to the conductive line through via holes, wherein the fourth connection lines and the gate line are isolated and arranged on the same layer, the fourth connection lines and the conductive line are arranged in parallel.

Alternatively, each self capacitance electrode is connected to the driving circuit through a corresponding conductive line, the conductive line and the gate line is isolated from each other and arranged on the same layer in parallel, and a layer on which the gate line is arranged is between a layer on which the self capacitance electrode is arranged and a layer on which the data line is arranged, the conductive line is connected to the corresponding self capacitance electrode through a via hole.

Alternatively, the in cell touch panel further includes a plurality of sub-pixels arranged on the side of the lower substrate facing the upper substrate and in a matrix manner, two data lines are arranged between adjacent columns of sub-pixels, a pixel group including every two adjacent rows of sub-pixels shares one gate line between the two adjacent rows of the sub-pixels, the conductive line is arranged in a gap between adjacent pixel groups.

Alternatively, the in cell touch panel further includes a third connection line which is arranged a region corresponding to a self capacitance electrode and connected to the self capacitance electrode through a via hole, wherein the third connection line and the gate line are isolated and arranged on the same layer in parallel.

Alternatively, the in cell touch panel further includes a plurality of fourth connection lines which are arranged a region corresponding to a conductive line and connected to the conductive line through via holes, wherein the fourth connection lines and the data line are isolated and arranged on the same layer, the fourth connection lines and the conductive line are arranged in parallel.

In another aspect, the present disclosure provides in some embodiments a display device comprising the above in cell touch panel.

The above in cell touch panel and the display device include an upper substrate and a lower substrate arranged opposite to each other; a self capacitance electrode arranged between the upper substrate and the lower substrate; a ground electrode corresponding to the self capacitance electrode; and a driving circuit configured to apply signals to the self capacitance electrode and the ground electrode. The driving circuit is used to apply the same driving signal to the self capacitance electrode and the ground electrode simultaneously during a touch phase. When signals on the self capacitance electrode and the ground electrode are the same during the touch phase, voltages on the self capacitance electrode and the ground electrode are theoretically the same, that is the voltage difference between the self capacitance electrode and the ground electrode are zero, so that the capacitance between the self capacitance electrode and the ground electrode (Based capacitance of the self capacitance electrode) is zero. Since the base capacitance of the self capacitance electrode is small, the body capacitance is relatively large compared with the base capacitance when body touching happens, so that capacitance change caused by body touching is relatively large, the touch SNR of the touch panel and the touch accuracy are improved.

### BRIEF DESCRIPTION OF THE DRAWINGS

FIG. 1 is a schematic view showing a wave form of a touch signal output from a driving circuit of the in cell touch panel to a self capacitance electrode and a corresponding ground electrode;

FIG. 2 is a schematic view showing a structure of the self capacitance electrode of the in cell touch panel according to at least one embodiment of the present disclosure;

FIG. 3 is a schematic view showing wave forms of signals on the self capacitance electrode, a common electrode, a signal line and a gate line during a touching phase;

FIG. 4a-4c are schematic views showing the common electrode according to at least one embodiment of the present disclosure;

FIG. 5a-5c are schematic views showing the in cell touch panel according to at least one embodiment of the present disclosure;

FIG. 6a is a top view of the in cell touch panel according to at least one embodiment of the present disclosure;

FIG. 6b is a partial section view of the in cell touch panel according to at least one embodiment of the present disclosure;

FIG. 7a is another top view of the in cell touch panel according to at least one embodiment of the present disclosure;

FIG. 7b is another partial section view of the in cell touch panel according to at least one embodiment of the present disclosure.

### DETAILED DESCRIPTION

An in cell touch panel and a display device will be described hereinafter in a clear and complete manner in conjunction with the drawings and embodiments.

The thickness and shapes of respective film layers shown in drawings do not show the real proportion, which are only used for illustration.

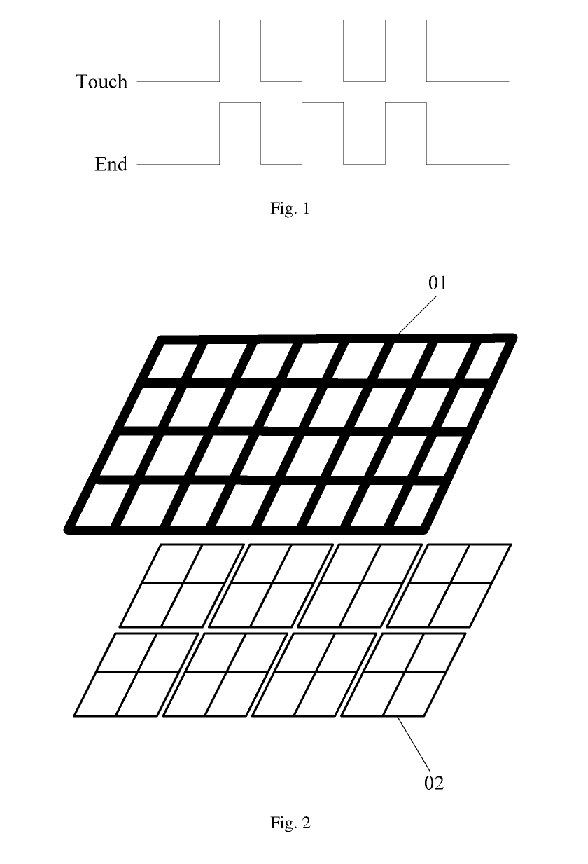

An in cell touch panel provided in an embodiment of the present disclosure including an upper substrate and a lower substrate opposite to each other; a self capacitance electrode arranged between the upper substrate and the lower substrate; a ground electrode corresponding to the self capacitance electrode; and a driving circuit applying a signal to the self capacitance electrode and the ground electrode. The driving circuit is used to apply the same touch scanning signal to the self capacitance electrode and the ground electrode. As shown in FIG. 1, Touch represents a waveform of the touch scanning signal output from the driving circuit to the self capacitance electrode. End represents a waveform of the touch scanning signal output from the driving circuit to the ground electrode.

In the in cell touch panel provided in an embodiment of the present disclosure, the driving circuit is used to apply the same touch scanning signal to the self capacitance electrode and the ground electrode during the touch phase. When the signals applied to the self capacitance electrode and the ground electrode are the same during the touch phase, in theory, a voltage on the self capacitance electrode and a voltage on the ground electrode are always the same, that is, voltage difference between the self capacitance electrode and the ground electrode is zero, so that the capacitance between the self capacitance electrode and the ground electrode (i.e. base capacitance of the self capacitance electrode) is theoretically zero. In practice, since RC loading among respective electrodes are not the same and the driving circuit has limitations on its bandwidth and gain, the base capacitance of the self capacitance electrode cannot be absolutely zero, but a small value. Since the base capacitance of the self capacitance electrode has a small value, the body capacitance during body touching is larger than the base capacitance, so that the change of the capacitance caused by body touching is relatively large, the touching SNR and touching accuracy are improved.

In one embodiment, the in cell touch panel may be applied to an LCD or an OLED, which will not be limited herein. In the following description, the in cell touch panel is applied to the LCD.

The in cell touch panel may be applied to Twisted Nematic (TN) LCD, Advanced Dimension Switch (ADS) LCD, High-Advanced Dimension Switch (ADS) LCD and In-Plane Switch (IPS) LCD.

Furthermore, the upper substrate and the lower substrate mentioned in an embodiment are a upper substrate and a lower substrate of a display screen arranged opposite to each other. For example, when the display screen is an LCD, the upper substrate is a color filter substrate and the lower substrate is an array substrate.

Furthermore, the self capacitance electrode and its corresponding ground electrode may be arranged on the same substrate or different substrates, which will not be limited herein. The two conditions will be described in the following embodiments.

First condition: the self capacitance electrode and its corresponding ground electrode are arranged on the different substrates.

In one embodiment, the self capacitance electrode is arranged on the upper substrate and the ground electrode is arranged on the lower substrate.

Alternatively, in the in cell touch panel provided in an embodiment of the present disclosure, the self capacitance electrode is arranged on a side of the upper substrate facing the lower substrate, the ground electrode includes a common electrode, a data line and a gate line which are arranged on a side of the lower substrate facing the upper substrate, the driving circuit is further used to apply a common electrode signal to the common electrode, apply a data signal to the date line and apply a gate signal to the gate line during a display phase.

As compared with an existing self capacitance electrode touch panel, in the above in cell touch panel, since the voltage difference between the self capacitance electrode and its corresponding ground electrode is theoretically zero during the touch phase, there is no capacitance between the self capacitance electrode and the ground electrode, the change of capacitance caused by the inversion of liquid crystals between the self capacitance electrode and the ground electrode can be avoided. In an existing self capacitance electrode touch panel, the liquid crystals between the self capacitance electrode and the ground electrode might be inverted. Since the liquid crystals functions as a dielectric layer between the self capacitance electrode and the ground electrode, the inversion of the liquid crystals will surely change the dielectric constant of the dielectric layer, so that coupling capacitance between the self capacitance electrode and the ground electrode changes. That is, the base capacitance of the self capacitance electrode is changed due to the inversion of the liquid crystals, so that touch accuracy is adversely affected.

Furthermore, in the in cell touch panel provided in the embodiments of the present disclosure, the self capacitance electrode may be made of a transparent conductive material or a metal material, which will not be limited herein.

Furthermore, as shown in FIG. 2, when the self capacitance electrode is made of a metal material, the in cell touch panel further includes a black matrix 01 arranged on a side of the upper substrate facing the lower substrate or a side of the lower substrate facing the upper substrate, and a projection of the black matrix 01 on the lower substrate covers a project of the self capacitance electrode on the lower substrate, so that aperture ratio of the self capacitance electrode is not adversely affected.

Usually, the touch screen has a touching density of millimeters. Therefore, the density and the area of the self capacitance electrode can be chosen according to the required touch density. The self capacitance electrode is usually designed as a 5 mm*5 mm square electrode. Since the display panel has a density of micrometers, one self capacitance electrode corresponds to multiple sub-pixels of the display panel. The projection of respective self capacitance electrodes on the lower substrate is of a grid shape.

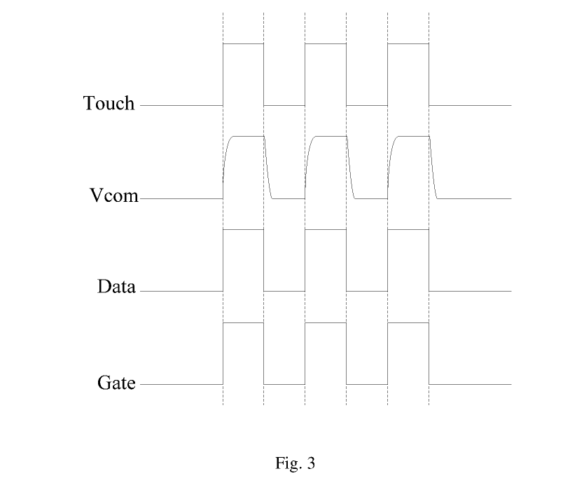

Furthermore, although the driving circuit applies the same touch scanning signal to the self capacitance electrode and the ground electrode during the touch phase, since the RC loadings of respective electrodes are not the same and the driving circuit has limitations on its bandwidth and gain, the touch scanning signal on the self capacitance electrode and the touch scanning signal on the ground electrode cannot be exactly the same like in theory. As shown in FIG. 3, Touch represents a waveform of the touch scanning signal on the self capacitance electrode, Vcom represents a waveform of the touch scanning signal on the common electrode, Data represents a waveform of the touch scanning signal on the data line, and Gate represents a waveform of the touch scanning signal on the gate line.

Therefore, in order to keep the touch scanning signals on the self capacitance electrode and the ground electrode consistent as possible, RC loadings of respective electrodes should be reduced. Among the self capacitance electrode, the common electrode, the data line and the gate line, the common electrode has a largest capacitance to the ground (the capacitance to the ground means a capacitance of one electrode to the other three, for example, the capacitance of the common electrode to the ground means the capacitance of the common electrode to the self capacitance electrode, the gate line and the data line). That is, the common electrode has a largest capacitance, it is important to reduced the capacitance of the common electrode.

Alternatively, the common electrode is divided into multiple common sub-electrodes to reduced the capacitance of the common electrode. Since each common sub-electrode has a relative small area, the capacitance of the common sub-electrode to the ground may be reduced, and the capacitance the whole common electrode to the ground may be reduced.

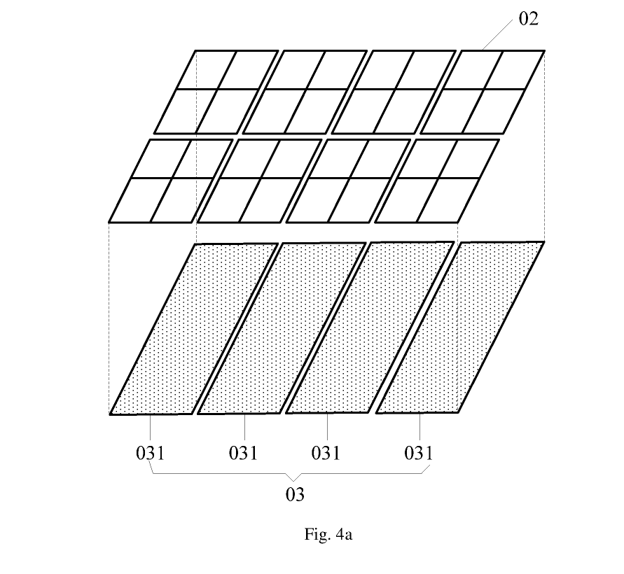

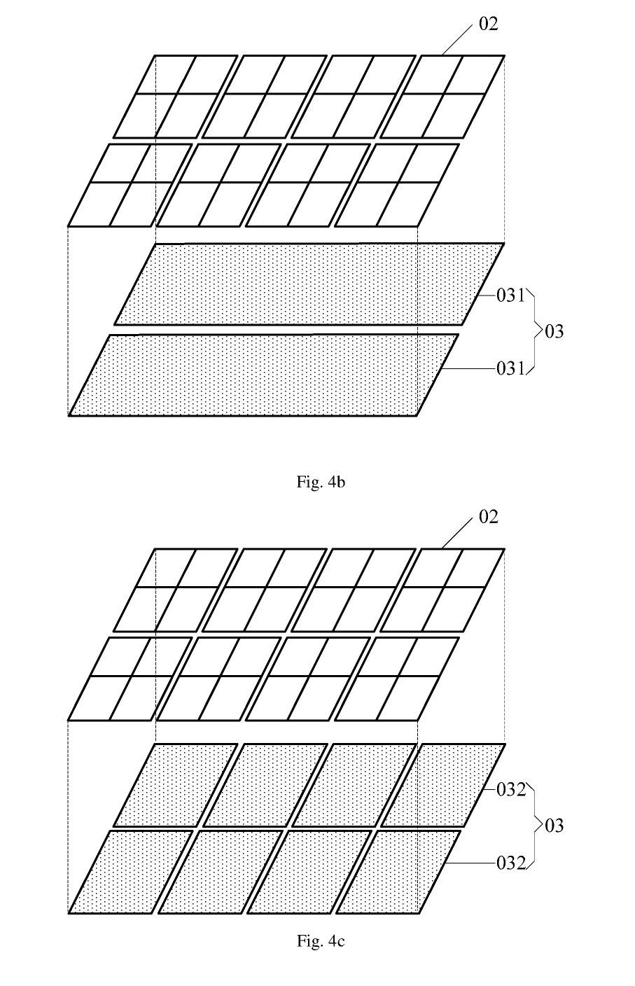

Alternatively, in the in cell touch panel, when the self capacitance electrodes are arranged in a matrix, as shown in FIG. 4a, the common electrode 03 is divided into strip-like common sub-electrodes 031 corresponding to each column of self capacitance electrodes; or as shown in FIG. 4b, the common electrode 03 is divided into strip-like common sub-electrodes 031 corresponding to each row of self capacitance electrodes.

As shown in FIG. 4c, the common electrode 03 may be divided into block-like common sub-electrodes 032 corresponding to respective self capacitance electrodes.

Furthermore, in the in cell touch panel, the resistance of the common electrode may be reduced so as to reduce RC loading of the common electrode.

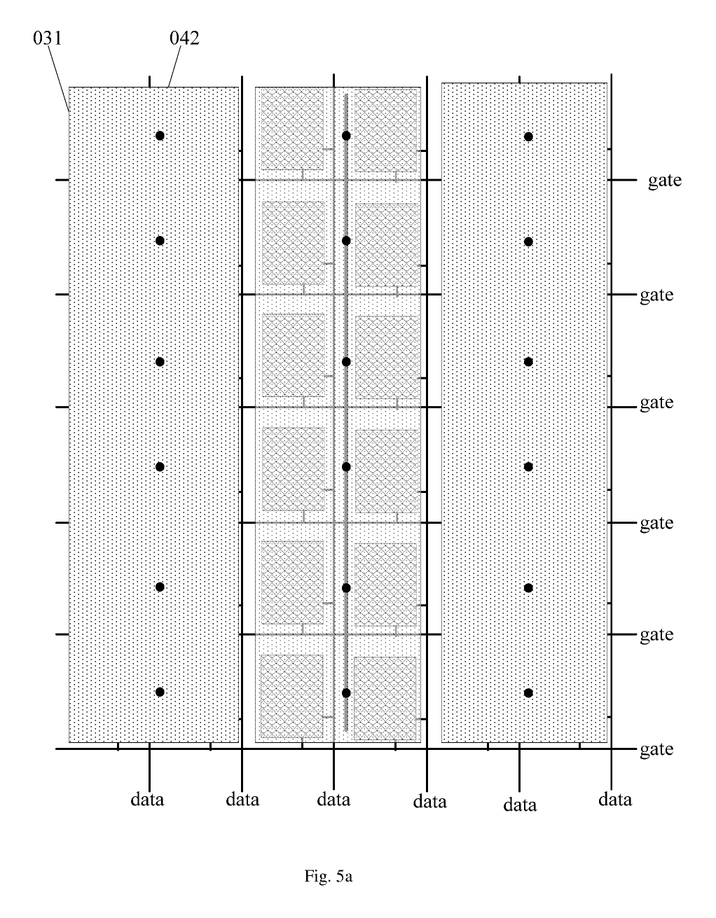

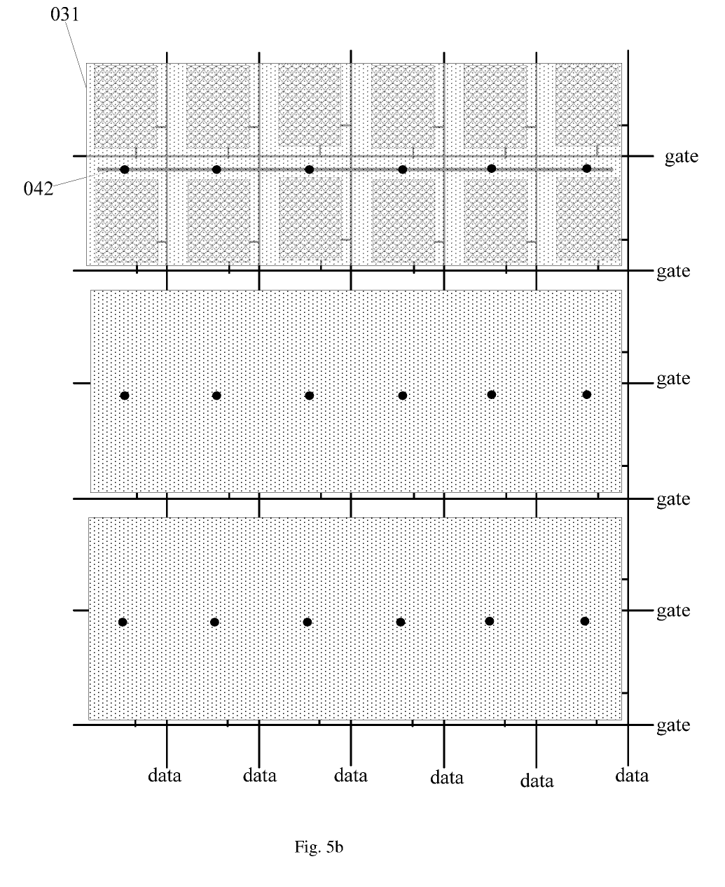

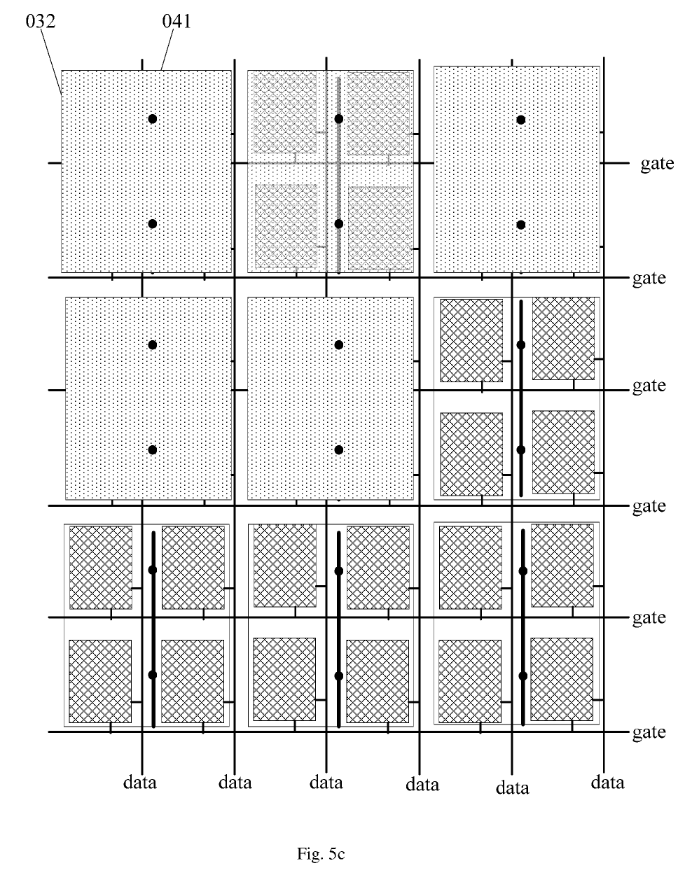

As shown in FIG. 5c, when the common electrode 03 is divided into block-like common sub-electrodes 32 corresponding to respective self capacitance electrodes, the in cell touch panel further includes a first connection line 041 arranged in a region corresponding to the block-like common sub-electrode 032 and being connected to the block-like common sub-electrode 032 through a via hole. The first connection line 041 and the data line are isolated, arranged in the same layer and in parallel; or the first connection line 041 and the gate line are isolated, arranged in the same layer and in parallel (FIG. 5c only shows that the first connection line and the data line are arranged in parallel).

The first connection line is connected to the common sub-electrode in parallel, so that the resistance of the common sub-electrode is reduced. Furthermore, the first connection line and the data line (or the gate line) are arranged on the same layer and in parallel, the pattern of the data line (or the gate line) is adjusted to manufacture the date line and the first connection line (or the gate line and the first connection line), no new process needs to be added during manufacturing, the procedure is simplified, the production cost is saved and the manufacturing efficiency is improved. Furthermore, the first connection line and the data line (or the gate line) are arranged in parallel, so as to facilitate the connection between the first connection line and the common sub-electrode and guarantee that the first connection line does not cross the data line (or the gate line) and avoid cross interference among electrodes.

In the in cell touch panel provided in an embodiment of the present disclosure, each block-like common sub-electrode is connected to at least one first connection line in parallel, the more the first connection lines which are connected to the block-like common sub-electrode is, the smaller the total resistance of the respective common sub-electrodes and corresponding first connection lines is. However, the more the first connection lines which are connected to the block-like common sub-electrode is, the smaller the aperture ration is. Therefore, the amount of the first connection lines to be connected to the block-like common sub-electrode is selected as needed.

As shown in FIG. 5a, when the common electrode 03 is divided into stripe-like common sub-electrodes 031 corresponding to each column of self capacitance electrodes, the in cell touch panel further includes a second connection line 041 arranged in a region corresponding to the stripe-like common sub-electrode 031 and being connected to the stripe-like common sub-electrode 031 through a via hole. The second connection line 042 and the data line are isolated, arranged in the same layer and in parallel. As shown in FIG. 5b, when the common electrode 03 is divided into stripe-like common sub-electrodes 031 corresponding to each row of self capacitance electrodes, the in cell touch panel further includes a second connection line 041 arranged in a region corresponding to the stripe-like common sub-electrode 031 and being connected to the stripe-like common sub-electrode 031 through a via hole. The second connection line 042 and the gate line are isolated, arranged in the same layer and in parallel.

Based on the same principle of the first connection line, each stripe-like common sub-electrode is connected at least one second connection line in parallel.

Furthermore, the in cell touch panel further includes a plurality of sub-pixels arranged on a side of the lower substrate facing the upper substrate in a matrix manner. When the first connection line is arranged at the same layer with the data line, the first connection line is arranged in a region corresponding to a block-like common sub-electrode and between adjacent columns of sub-pixels. When the first connection line is arranged on the same layer with the gate line, the first connection line is arranged in a region corresponding to a block-like common sub-electrode and between adjacent rows of sub-pixels. Similarly, When the second connection line is arranged at the same layer with the data line, the first connection line is arranged in a region corresponding to a stripe-like common sub-electrode and between adjacent columns of sub-pixels. When the first connection line is arranged on the same layer with the gate line, the first connection line is arranged in a region corresponding to a stripe-like common sub-electrode and between adjacent rows of sub-pixels.

The above touch panel is described in the condition that the self capacitance electrode and the corresponding ground electrode are arranged on the upper substrate and lower substrate respectively. The following description is based on the condition that the self capacitance electrode and the corresponding ground electrode are arranged on the same substrate.

The second condition is that the self capacitance electrode and the corresponding ground electrode are arranged on the same substrate.

In practice, the self capacitance electrode and the corresponding ground electrode are arranged on the lower substrate.

When the self capacitance electrode and the corresponding ground electrode are both arranged on the lower substrate, the ground electrode includes the common electrode, the data line and the gate line. The driving circuit is used to apply a common electrode signal to the common electrode, apply a data signal to the data line and apply a gate scanning signal to the gate line.

Alternatively, in order to simply the manufacturing process, the self capacitance electrode is arranged on a side of the lower substrate facing the upper substrate and the self capacitance is also used as the common electrode. The ground electrode includes the data line and the gate line which are arranged on a side of the lower substrate facing the upper substrate. The driving circuit is used to apply the common electrode signal to all self capacitance electrodes, apply the data signal to the data line and apply the gate scanning signal to the gate line. Since the self capacitance electrode is also used as the common electrode, it is not necessary to add a process for forming the self capacitance electrode during manufacturing, the common electrode is divided during the conventional process for manufacturing the common electrode, so that a pattern of all self capacitance electrodes is formed by a signal patterning process, the manufacturing procedure is simplified and the manufacturing cost is saved.

Furthermore, each self capacitance electrode needs to be connected to the driving circuit via a corresponding conductive line. During manufacturing, the conductive line is arranged on the same layer with the data line or the gate line so as to simplifying the manufacturing process.

Specifically, each self capacitance electrode may be connected to the driving circuit by at least one conductive line which will not be limited herein.

Alternatively, when a layer on which the data line is located is between the layers on which the self capacitance electrode and the gate line are located respectively, the conductive line and the data line are isolated from each other, are arranged on the same layer in parallel, and the conductive line is connected to the corresponding self capacitance electrode thought a via hole.

Alternatively, when a layer on which the gate line is located is between the layers on which the self capacitance electrode and the data line are located respectively, the conductive line and the gate line are isolated from each other, are arranged on the same layer in parallel, and the conductive line is connected to the corresponding self capacitance electrode thought a via hole.

Furthermore, the above in cell touch panel further includes a plurality of sub-pixels arranged on a side of the lower substrate facing the upper substrate and in a matrix manner. When the conductive line is arranged on the same layer with the data line, two gate lines are arranged between adjacent rows of sub-pixels, a pixel group including every two adjacent rows of sub-pixels shares one data line between the two adjacent rows of the sub-pixels, the conductive line is arranged in a gap between adjacent pixel groups. Therefore, the conductive line is located in a display region of the display panel, so that the border is not occupy, the width of the border may be reduced to the greatest extend.

Alternatively, the above in cell touch panel may includes a plurality of sub-pixels arranged on a side of the lower substrate facing the upper substrate and in a matrix manner. When the conductive line is arranged on the same layer with the gate line, two data lines are arranged between adjacent rows of sub-pixels, a pixel group including every two adjacent rows of sub-pixels shares one gate line between the two adjacent rows of the sub-pixels, the conductive line is arranged in a gap between adjacent pixel groups. Therefore, the conductive line is located in a display region of the display panel, so that the border is not occupy, the width of the border may be reduced to the greatest extend.

Furthermore, the resistance of the self capacitance electrode maybe reduced to the greatest extend so that the waveforms of the touch scanning signals applied on the self capacitance electrode and the corresponding ground electrode are as consistent as possible.

Alternatively, when the layer on which the data line is arranged is between the layer on which the self capacitance electrode is arranged and the layer on which the gate line is arranged, the in cell touch panel further includes a third connection line which is arranged a region corresponding to a self capacitance electrode and connected to the self capacitance electrode through a via hole. The third connection line and the data line are isolated and arranged on the same layer in parallel. The third connection line is connected to the self capacitance electrode in parallel so that the resistance of the self capacitance electrode is reduced. Since the third connection line is arranged on the same layer with the data line, it is not necessary to add new process during manufacturing, a pattern of the data line layer is modified to manufacturing the third connection line and the data line simultaneously, so that the manufacturing procedure is simplified, the manufacturing cost is saved and the manufacturing efficiency is improved. Furthermore, the third connection line and the data line is arranged in parallel so as to facilitate the connection between the third connection line and the self capacitance electrode, guarantee the third connection line not crossing the data line, and avoid cross interference among electrodes.

Similarly, when the layer on which the gate line is arranged is between the layer on which the self capacitance electrode is arranged and the layer on which the data line is arranged, the in cell touch panel further includes a third connection line which is arranged a region corresponding to a self capacitance electrode and connected to the self capacitance electrode through a via hole. The third connection line and the gate line are isolated and arranged on the same layer in parallel.

Specifically, in the in cell touch panel provided in an embodiment of the present disclosure, each self capacitance electrode may be connected to at least on third connection line in parallel, which will not be limited herein.

Furthermore, in the in cell touch panel provided in an embodiment of the present disclosure, the waveform distortion on the self capacitance electrode may be reduced by reducing the resistance on the conductive line.

When the layer on which the data line is arranged is between the layer on which the self capacitance electrode is arranged and the layer on which the gate line is arranged, the in cell touch panel further includes a plurality of fourth connection lines which are arranged a region corresponding to a conductive line and connected to the conductive line through via holes. The fourth connection lines and the gate line are isolated and arranged on the same layer, the fourth connection lines and the conductive line are arranged in parallel.

Alternatively, when the layer on which the gate line is arranged is between the layer on which the self capacitance electrode is arranged and the layer on which the data line is arranged, the in cell touch panel further includes a plurality of fourth connection line which are arranged on a region corresponding to a conductive line and connected to the conductive line through via holes. The fourth connection lines and the data line are isolated and arranged on the same layer, the fourth connection lines and the conductive line are arranged in parallel.

Furthermore, when the in cell touch panel is applied to a ADS LCD, the common electrode is arranged below the slit-like pixel electrode, that is the common electrode is arranged between the lower substrate and the pixel electrode, and a passivation layer is arranged between the common electrode and the pixel electrode. When the in cell touch panel is applied to HADS LCD, the common electrode is arranged above the plate-like pixel electrode, that is the pixel electrode is arranged between the lower substrate and the common electrode, and a passivation layer is arranged between the pixel electrode and the common electrode.

Two examples in the second condition are described hereinafter.

### Example 1

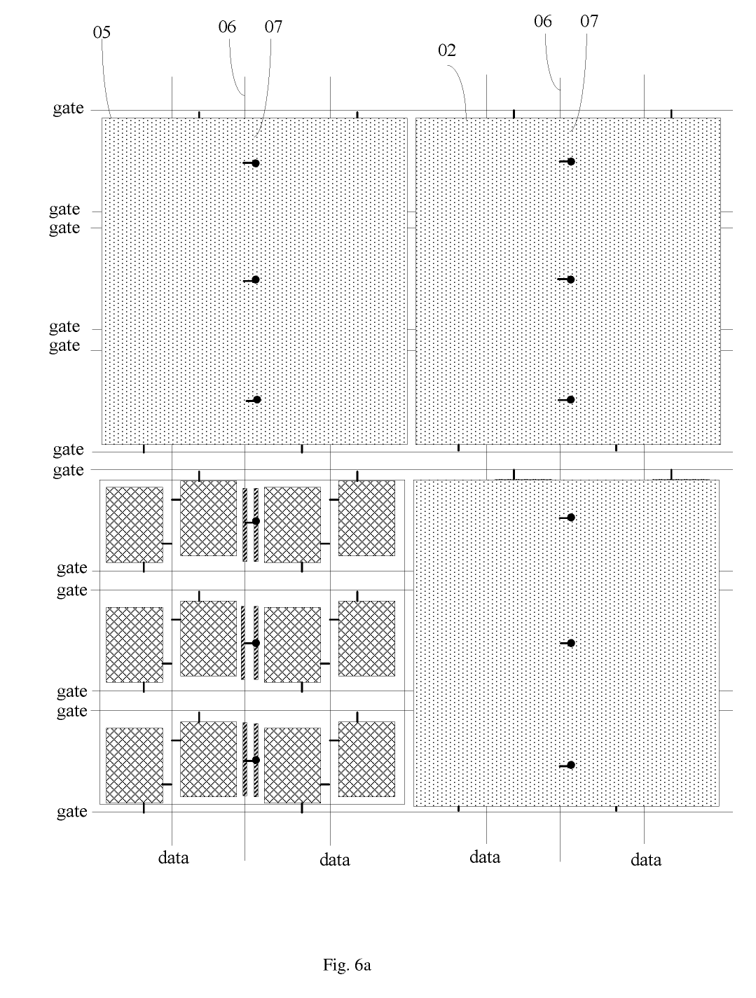

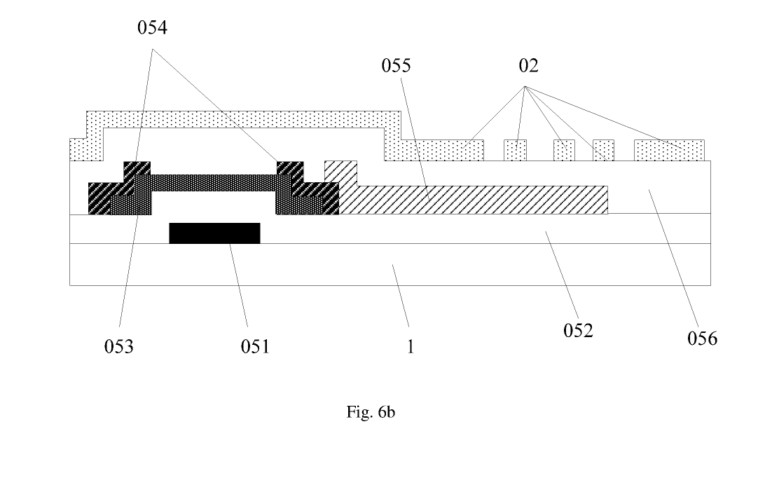

As shown in FIG. 6a, the in cell touch panel includes a plurality of sub-pixels 05 which are arranged on a side of the lower substrate 1 facing the upper substrate and in a matrix manner (FIG. 6a does not show the specific structure of the sub-pixel); two gate lines arranged between adjacent rows of sub-pixels 05; a data line shared by two adjacent columns of sub-pixels 05 which form a pixel group; a self capacitance electrode 02 also used as the common electrode; a conductive line 06 connecting a corresponding self capacitance electrode to the driving circuit, wherein the conductive line 06 and the data line are isolated and arranged on the same layer in parallel, and the conductive line 06 is connected to the corresponding self capacitance electrode 02 through a via hole and arranged in a gap between adjacent pixel groups. The in cell touch panel further includes a plurality of fourth connection lines 06 which are arranged on regions corresponding to the conductive lines 04 and are connected to the conductive lines 06 through via holes. Each fourth connection line 07 and the gate line are isolated and arranged on the same layer, and the fourth connection line 07 and the conductive line 06 are in parallel.

As shown in FIG. 6b, each sub-pixel 05 includes a gate electrode 051, a gate insulating layer 052, an active layer 053, a source/drain electrode 054, a pixel electrode 055, a passivation layer 056 which are sequentially arranged on the lower substrate 1. The data line and the sour/drain electrode 054 are arranged on the same layer, the gate line and the gate electrode 051 are arranged on the same layer, the self capacitance 02 is arranged above the passivation layer 056 (FIG. 6b does not show the data line and the gate line).

In practice, existing patterning procedure may be used to form each layer on the lower substrate of the in cell touch panel, for example, seven times patterning procedure: patterning of the gate electrode, the gate line and the fourth connection lines→patterning of the active layer→patterning of the pixel electrode→patterning of the gate insulating layer→patterning of the conductive line, the data line and the source/drain electrode→patterning the passivation layer→patterning of the self capacitance electrode. Of course, five times patterning procedure, six times patterning procedure or eight time pattering procedure may be used according to practical design, which will not be limited herein.

### Example 2

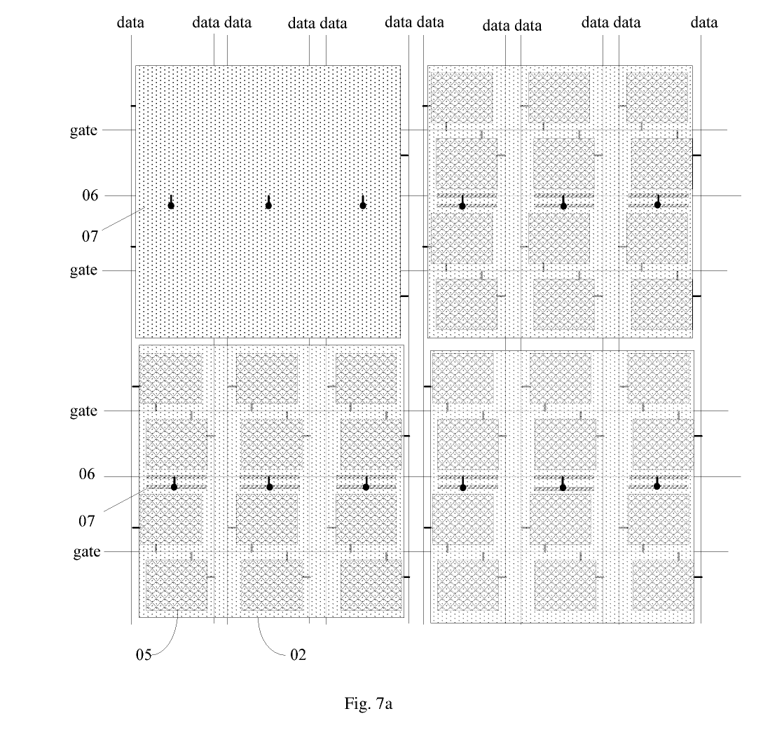

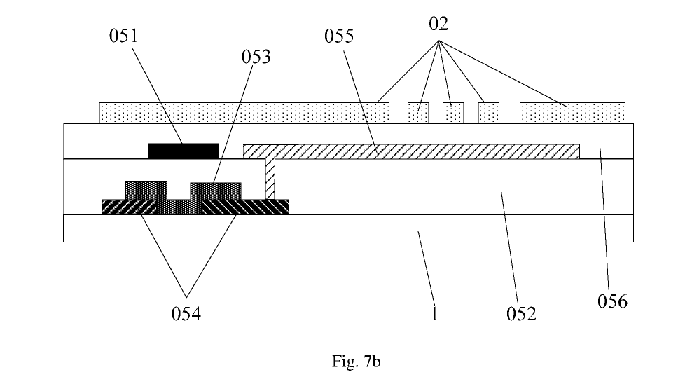

As shown in FIG. 7a, the in cell touch panel includes a plurality of sub-pixels 05 which are arranged on a side of the lower substrate 1 facing the upper substrate and in a matrix manner (FIG. 7a does not show the specific structure of the sub-pixel); two data lines arranged between adjacent columns of sub-pixels 05; a gate line shared by two adjacent rows of sub-pixels 05 which form a pixel group; a self capacitance electrode 02 also used as the common electrode; a conductive line 06 connecting a corresponding self capacitance electrode to the driving circuit, wherein the conductive line 06 and the gate line are isolated and arranged on the same layer in parallel, and the conductive line 06 is connected to the corresponding self capacitance electrode 02 through a via hole and arranged in a gap between adjacent pixel groups. The in cell touch panel further includes a plurality of fourth connection lines 06 which are arranged on regions corresponding to the conductive lines 04 and are connected to the conductive lines 06 through via holes. Each fourth connection line 07 and the data line are isolated and arranged on the same layer, and the fourth connection line 07 and the conductive line 06 are in parallel.

As shown in FIG. 7b, each sub-pixel 05 includes a source/drain electrode 054, an active layer 053, a gate insulating layer 052, a gate electrode 051, a pixel electrode 055, a passivation layer 056 which are sequentially arranged on the lower substrate 1. The data line and the sour/drain electrode 054 are arranged on the same layer, the gate line and the gate electrode 051 are arranged on the same layer, the self capacitance 02 is arranged above the passivation layer 056 (FIG. 7b does not show the data line and the gate line).

In practice, existing patterning procedure may be used to form each layer on the lower substrate of the in cell touch panel, for example, seven times patterning procedure: patterning of the conductive line, the data line and the source/drain electrode→patterning of the active layer→patterning of the gate insulating layer→patterning of the gate electrode, the gate line and the fourth connection lines→patterning of the pixel electrode→patterning the passivation layer→patterning of the self capacitance electrode. Of course, five times patterning procedure, six times patterning procedure or eight time pattering procedure may be used according to practical design, which will not be limited herein.

Based on the same concept, an embodiment of the present disclosure further discloses a display device including the above in cell touch panel. The display device maybe any product or members having display functions, such as a cell phone, a laptop, a TV, a monitor, a notebook computer, a digital photo frame, a navigator and so on. The display device may be implemented by referring to above embodiments, which will not be repeated herein.

The above in cell touch panel and the display device include an upper substrate and a lower substrate arranged opposite to each other; a self capacitance electrode arranged between the upper substrate and the lower substrate; a ground electrode corresponding to the self capacitance electrode; and a driving circuit configured to apply signals to the self capacitance electrode and the ground electrode. The driving circuit is used to apply the same driving signal to the self capacitance electrode and the ground electrode simultaneously during a touch phase. When signals on the self capacitance electrode and the ground electrode are the same during the touch phase, voltages on the self capacitance electrode and the ground electrode are theoretically the same, that is the voltage difference between the self capacitance electrode and the ground electrode are zero, so that the capacitance between the self capacitance electrode and the ground electrode (Based capacitance of the self capacitance electrode) is zero. Since the base capacitance of the self capacitance electrode is small, the body capacitance is relatively large compared with the base capacitance when body touching happens, so that capacitance change caused by body touching is relatively large, the touch SNR of the touch panel and the touch accuracy are improved.

The above are merely the preferred embodiments of the present disclosure. It should be appreciated that, a person skilled in the art may make further modifications and improvements without departing from the spirit of the present disclosure, and these modifications and improvements shall also fall within the scope of the present disclosure.

What is claimed is:

1. An in cell touch panel comprising:
an upper substrate and a lower substrate arranged opposite to each other;
a self capacitance electrode between the upper substrate and the lower substrate;
a ground electrode corresponding to the self capacitance electrode; and
a driving circuit configured to apply a signal to the self capacitance electrode and the ground electrode,
wherein the driving circuit is configured to apply a same touch scanning signal to the self capacitance electrode and the ground electrode during a touch phase.

2. The in cell touch panel according to claim 1, wherein, the self capacitance electrode is arranged on a side of the upper substrate facing the lower substrate, the ground electrode comprises a common electrode, a data line and a gate line which are arranged on a side of the lower substrate facing the upper substrate, the driving circuit is further configured to apply a common electrode signal to the common electrode, a data signal to the data line and a gate scanning signal to the gate line during a display phase.

3. The in cell touch panel according to claim 2, further comprising a black matrix arranged on one of the side of the upper substrate facing the lower substrate and the side of the lower substrate facing the upper substrate, wherein a projection of the black matrix on the lower substrate overlaps a projection of the self capacitance electrode on the lower substrate.

4. The in cell touch panel according to claim 2, wherein
the self capacitance electrodes are arranged in a matrix manner,
the common electrode is divided into a plurality of block-like common sub-electrodes corresponding to respective self capacitance electrodes.

5. The in cell touch panel according to claim 2, wherein
the self capacitance electrodes are arranged in a matrix manner, the common electrode is divided into a plurality of stripe-like common sub-electrodes corresponding to respective columns of self capacitance electrodes.

6. The in cell touch panel according to claim 2, wherein
the self capacitance electrodes are arranged in a matrix manner, the common electrode is divided into a plurality of stripe-like common sub-electrodes corresponding to respective rows of self capacitance electrodes.

7. The in cell touch panel according to claim 4, further comprising a first connection line arranged on a region corresponding to a block-like self capacitance electrode and connected to the block-like self capacitance electrode through a via hole,
wherein the first connection line and one of the gate line and the data line are isolated from each other, and arranged on the same layer in parallel.

8. The in cell touch panel according to claim 5, further comprising a second connection line arranged on a region corresponding to a strip-like self capacitance electrode and connected to the stripe-like self capacitance electrode through a via hole,
wherein the second connection line and the data line are isolated from each other, and arranged on the same layer in parallel.

9. The in cell touch panel according to claim 6, further comprising a second connection line arranged on a region corresponding to a strip-like self capacitance electrode and connected to the stripe-like self capacitance electrode through a via hole,
wherein the second connection line and the gate line are isolated from each other, and arranged on the same layer in parallel.

10. The in cell touch panel according to claim 1, wherein the self capacitance electrode is arranged on a side of the lower substrate facing the upper substrate and the self capacitance electrode is also used as the common electrode,
the ground electrode comprises a data line and a gate line arranged on a side of the lower substrate facing the upper substrate;
the driving circuit is further configured to apply a common electrode signal to the self capacitance electrode, a data signal to the data line and a gate scanning signal to the gate line during the display phase.

11. The in cell touch panel according to claim 10, wherein each self capacitance electrode is connected to the driving circuit through a corresponding conductive line, the conductive line and the data line is isolated from each other and arranged on the same layer in parallel, and a layer on which the data line is arranged is between a layer on which the self capacitance electrode is arranged and a layer on which the gate line is arranged, the conductive line is connected to the corresponding self capacitance electrode through a via hole.

12. The in cell touch panel according to claim 11, further comprising a plurality of sub-pixels arranged on the side of the lower substrate facing the upper substrate and in a matrix manner,
two gate lines are arranged between adjacent rows of sub-pixels, a pixel group including every two adjacent columns of sub-pixels shares one data line between the two adjacent columns of the sub-pixels, the conductive line is arranged in a gap between adjacent pixel groups.

13. The in cell touch panel according to claim 11, further comprising a third connection line which is arranged a region corresponding to a self capacitance electrode and connected to the self capacitance electrode through a via hole, wherein the third connection line and the data line are isolated and arranged on the same layer in parallel.

14. The in cell touch panel according to claim 11, further comprising a plurality of fourth connection lines which are arranged a region corresponding to a conductive line and connected to the conductive line through via holes, wherein the fourth connection lines and the gate line are isolated and arranged on the same layer, the fourth connection lines and the conductive line are arranged in parallel.

15. The in cell touch panel according to claim 10, wherein each self capacitance electrode is connected to the driving circuit through a corresponding conductive line, the conductive line and the gate line is isolated from each other and arranged on the same layer in parallel, and a layer on which the gate line is arranged is between a layer on which the self capacitance electrode is arranged and a layer on which the data line is arranged, the conductive line is connected to the corresponding self capacitance electrode through a via hole.

16. The in cell touch panel according to claim 15, further comprising a plurality of sub-pixels arranged on the side of the lower substrate facing the upper substrate and in a matrix manner,
two data lines are arranged between adjacent columns of sub-pixels, a pixel group including every two adjacent rows of sub-pixels shares one gate line between the two adjacent rows of the sub-pixels, the conductive line is arranged in a gap between adjacent pixel groups.

17. The in cell touch panel according to claim 15, further comprising a third connection line which is arranged a region corresponding to a self capacitance electrode and connected to the self capacitance electrode through a via hole, wherein the third connection line and the gate line are isolated and arranged on the same layer in parallel.

18. The in cell touch panel according to claim 15, further comprising a plurality of fourth connection lines which are arranged a region corresponding to a conductive line and connected to the conductive line through via holes, wherein the fourth connection lines and the data line are isolated and arranged on the same layer, the fourth connection lines and the conductive line are arranged in parallel.

19. The in cell touch panel according to claim 16, further comprising a plurality of fourth connection lines which are arranged a region corresponding to a conductive line and connected to the conductive line through via holes, wherein the fourth connection lines and the data line are isolated and arranged on the same layer, the fourth connection lines and the conductive line are arranged in parallel.

20. A display device comprising the in cell touch panel according to claim 1.
